(19) United States
(12) Patent Application Publication
(10) Pub. No.: US 2007/0268576 A1
(43) Pub. Date: Nov. 22, 2007

(54) Waterproof zoom binocular telescope

(76) Inventor: Chun-Mao Lee, Taipei (TW)

Correspondence Address: BACON & THOMAS, PLLC, 625 SLATERS LANE, FOURTH FLOOR, ALEXANDRIA, VA, 22314, US

(21) Appl. No.: 11/437,685

(22) Filed: May 22, 2006

(51) Int. Cl. G02B 23/00

(52) U.S. Cl. 359/407; 359/699

(57) ABSTRACT

A waterproof zoom binocular telescope includes a left lens barrel, a right lens barrel, an ocular base disposed at an end of each lens barrel, and a synchronous belt sprocket disposed at the connecting position of the two ocular bases. Each ocular base includes an ocular module, and the two ocular modules separately include a zoom unit. Each zoom unit and the synchronous belt sprocket are connected with a synchronous belt to form a transmission chain structure. An eccentric cam is installed between two external common tangents of each ocular module and the synchronous belt sprocket for tightly pressing the two synchronous belts. If any one of the zoom units rotates, the transmission chain structure effectively drives the synchronous belt to rotate another zoom unit correspondingly.

### FIELD OF THE INVENTION

The present invention relates to a binocular telescope, and more particularly to a waterproof zoom binocular telescope.

### BACKGROUND OF THE INVENTION

The present binocular telescopes are divided into three main types:

1. General center-focusing binocular telescopes: A central handwheel is used for adjusting an object lens or a field lens to achieve the effect of controlling an observing distance, and an ocular lens on one side is used to assist the adjustment to compensate the difference of the vision of the left and right eyes. Since there is no sealing mechanism for this type of binocular telescopes, therefore these binocular telescopes do not have waterproof and mold-resisting functions and cannot be used and stored for a long time.

2. Fixed-amplification waterproof binocular telescopes: This type of binocular telescopes is substantially the same as the foregoing type of binocular telescopes, but an effective waterproof sealing mechanism is added to overcome the problem of using the binocular telescopes in poor conditions of an environment. However, this type of binocular telescopes has a shortcoming that the amplification factor cannot be adjusted.

3. General zoom binocular telescopes: This type of binocular telescopes includes a central focusing structure and its zoom function can be achieved by driving a zoom wrench, and a steel belt is used to drive the zoom mechanisms on the left and right sides of the binocular telescope to rotate synchronously for zooming in and out. However, this type of binocular telescopes usually comes with a zoom difference between the independent system of the left and right lens barrels due to the manufacturing error of the structure, and these binocular telescopes do not have the waterproof function and cannot operate at a damp environment.

Therefore, finding a way of designing a binocular telescope that can maintain the convenience of focusing provided by the first type of binocular telescopes, the waterproof and mold-resisting functions provided by the second type of binocular telescopes, and the continuous zoom function of the third type of binocular telescopes as well as effectively overcome the shortcomings of the asynchronous zoom of the left and right lens barrels, amplification factor difference, excessively tight zoom unit, and waterproof seal demands immediate attentions and feasible solutions.

### SUMMARY OF THE INVENTION

In view of the shortcomings of the prior art, the inventor of the present invention based on years of experience to conduct extensive researches and experiments, and finally designed and developed a waterproof zoom binocular telescope in accordance with the present invention to overcome the shortcomings of the prior art.

Therefore, it is a primary objective of the present invention to provide a waterproof zoom binocular telescope that comprises a left lens barrel, a right lens barrel, an ocular base disposed at an end of each lens barrel, a synchronous belt sprocket disposed at the connecting position of the two ocular bases, and each ocular base includes an ocular module, and the two ocular modules separately includes a zoom unit. Each zoom unit and the synchronous belt sprocket are connected with a synchronous belt to form a transmission chain structure. An eccentric cam is installed between two external common tangents of each ocular module and the synchronous belt sprocket for tightly pressing the two synchronous belts. If any one of the zoom units rotates, the transmission chain structure effectively drives the synchronous belt to rotate another zoom unit correspondingly.

### BRIEF DESCRIPTION OF THE DRAWINGS

FIG. 1 is a front cross-sectional view a binocular telescope of the present invention;

FIG. 2 is a side cross-sectional view of a binocular telescope of the present invention;

FIG. 3 is a schematic view of a preferred embodiment of the present invention; and

FIG. 4 is a perspective view of the structure as depicted in FIG. 3.

### DETAILED DESCRIPTION OF THE PREFERRED EMBODIMENTS

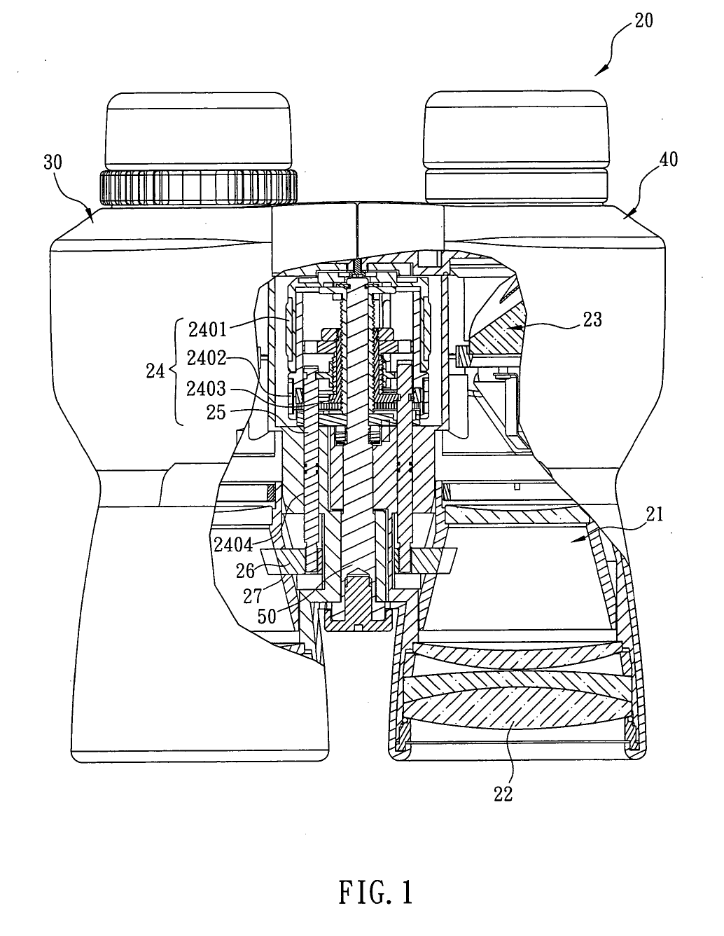

Referring to FIGS. 1 to 3, a binocular telescope 20 comprises a right lens barrel 30, a left lens barrel 40 and an axle 50, and the two lens barrels 30, 40 are pivotally and separately coupled to the corresponding sides of the axle 50 and rotated up and down with respect to the axis of the axle 50, and its optical system includes an object lens module 21, a prism module 23 and an ocular module 32, 42. The object lens module 21 receives a light from the outside, and the prism module 23 goes through the processes of projecting, reflecting, and refracting the light (or known as an optical path), and then the ocular module 32 42 projects the light onto a user's eye. The axle 50 sequentially includes a common axle, a focusing wheel 2401 (or known as a focal length adjusting wheel) and an accommodation wheel 2402 (or a vision accommodation wheel) which are generally called a central adjusting mechanism 24 disposed along the axis of the axle 50 for adjusting the focal length and vision, and the central adjusting mechanism 24 further includes a screw thread portion 2403 and two elevation driving rods 25. The screw thread portion 2403 is situated between the focusing wheel 2401 and the accommodation wheel 2402 and connected separately to an end of the two elevation driving rods 25, and another end of the two elevation driving rods 25 is passed separately to a through hole 2404 of each lens barrel 30, 40 and coupled to a connecting support arm 26, and the two connecting support arms 26 are coupled separately to an object lens module 21 of each lens barrel 30, 40, such that when the focusing wheel 2401 or the accommodation wheel 2402 is rotated, the screw thread portion 2403 can be rotated synchronously with the focusing wheel 2401 or the accommodation wheel 2402 for driving the two elevation driving rods 25 to move up and down, so as to move each object lens module 21 up and down according to the ascending and descending movements of the connecting support arm 26 and adjust the position of each object lens 22 to achieve the effect of adjusting the parameters of the optical system. Further, the two lens barrels 30, 40 separately include a connecting hole 27 for passing each connecting support arm 26 through the connecting hole 27 to connect the corresponding elevation driving rod 25 and object lens module 21. The connecting holes 27 can be sealed by a sealing ring (or an O-ring) to overcome the issue of sealing the central adjusting mechanism 24 with the internal cavity of each lens barrel 30, 40.

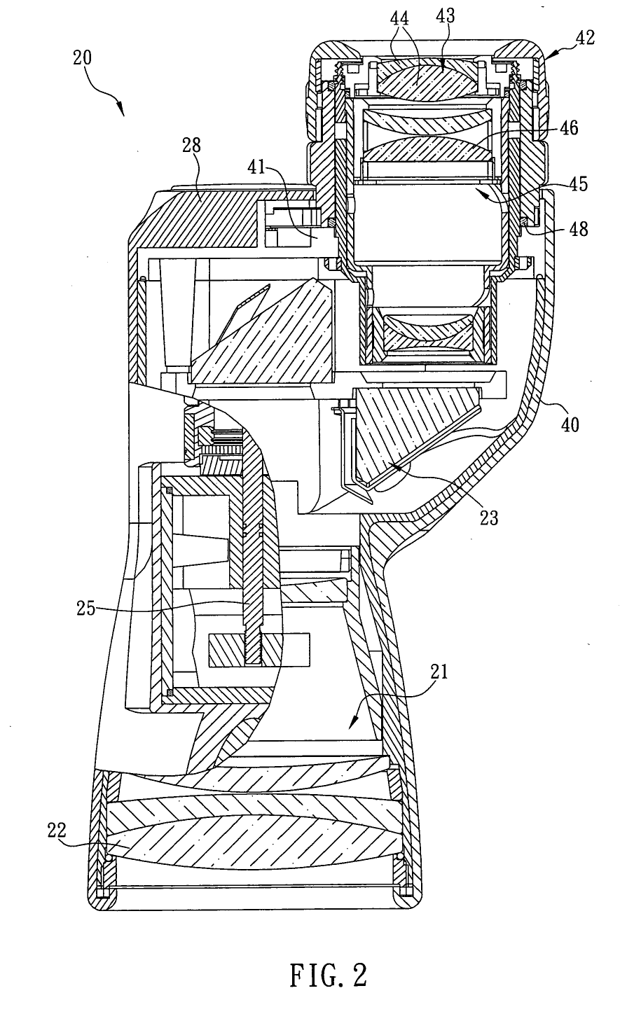

Referring to FIGS. 1 to 4 for a waterproof zoom binocular telescope of the present invention, an end of the right lens barrel 30 includes a right ocular base 31, and the right ocular base 31 includes a right ocular module 32, and the right ocular module 32 includes a right ocular unit 33 and a right zoom unit 35. The left lens barrel 40 includes a left ocular base 41 disposed at an end of the left lens barrel 40 and the left ocular base 41 includes a left ocular module 42 thereon, and the left ocular module 42 includes a left ocular unit 43 and a left zoom unit 45. The two ocular units 33, 43 separately include a plurality of ocular lenses 34, 44 arranged in sequence, and the two zoom units 35, 45 separately include a plurality of zoom lenses 46 arranged in sequence. The right zoom unit 35 includes a synchronous zoom rod 37 at the exterior of the right zoom unit 35, and the left zoom unit 45 includes a synchronous zoom wheel 47 at the exterior of the left zoom unit 45. The synchronous zoom rod 37 can be operated to adjust the relative position of each zoom lens in the right zoom unit 35 (such as the zoom lenses 46 shown in FIG. 2). The synchronous zoom wheel 47 can be rotated synchronously with the synchronous zoom rod 37, so as to adjust the relative position of each zoom lens 46 in the left zoom unit 45 for adjusting the zoom in/out factor. A sealing ring 48 is installed between each ocular module 32, 42 and the ocular base 31, 41 for sealing the gap between each ocular module 32, 42 and each ocular base 31, 41.

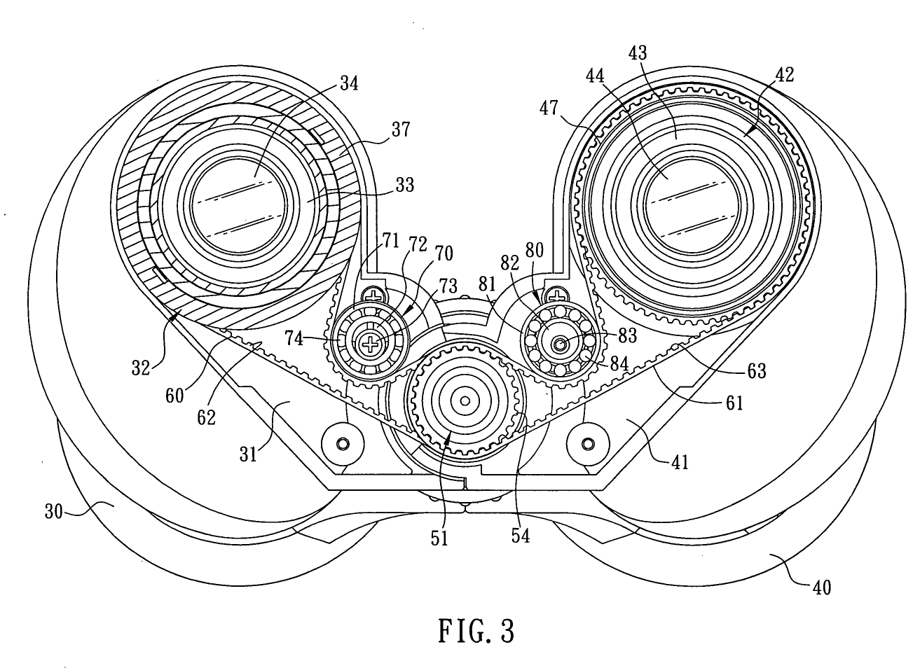

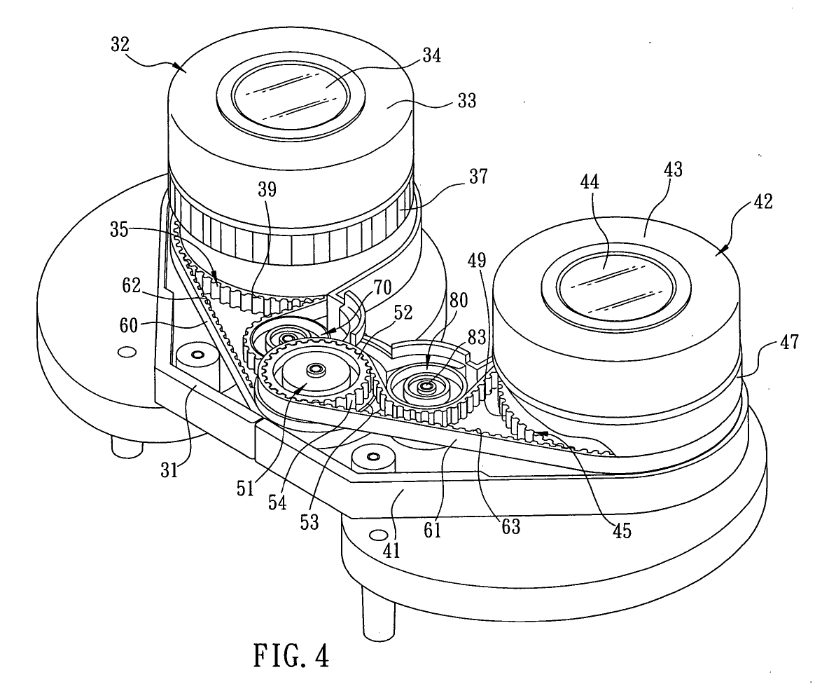

Referring to FIGS. 3 and 4, a synchronous belt sprocket 51 is installed at the connecting position of two ocular bases 31, 41 and the synchronous belt sprocket 51 is coaxially coupled with an end of the axle 50. The right ocular base 31 includes a first synchronous belt 60 mounted onto the right zoom unit 35 and the synchronous belt sprocket 51 and rotated with the synchronous zoom rod 37. The left ocular base 41 includes a second synchronous belt 61 mounted onto the left zoom unit 45 and the synchronous belt sprocket 51 and rotated with the synchronous belt sprocket 51. The synchronous belt sprocket 51 includes an upper layer structure 52 and a lower layer structure 53, and the upper layer structure 52 is coupled with the second synchronous belt 61, and the lower layer structure 53 is coupled to the first synchronous belt 60 to constitute a mutually and reciprocally secured transmission chain structure. To avoid the malfunction of the synchronization caused by a possible error of the lengths of the two synchronous belts 60, 61, the right ocular base 31 includes a right eccentric cam 70 disposed between two external common tangents of the synchronous zoom rod 37 and the synchronous belt sprocket 51. The left ocular base 41 includes a left eccentric cam 80 disposed between two external common tangents of the synchronous zoom wheel 47 and the synchronous belt sprocket 51 for separately pressing each synchronous belt 60, 61, so that each synchronous belt 60, 61 can be closely coupled with the synchronous belt sprocket 51 and the synchronous zoom rod 37 or the synchronous zoom wheel 47, so as to achieve the adjusting and compensating effects and an efficient synchronous rotation.

Referring to FIG. 3, the internal surface of each synchronous belt 60, 61 is coupled to the external periphery of the synchronous belt sprocket 51 and the synchronous zoom rod 37 or the synchronous zoom wheel 47. The first synchronous belt 60 has two corresponding sides extended between the synchronous zoom rod 37 and the synchronous belt sprocket 51, wherein the external surface of a side adjacent to the right eccentric cam 70 is pressed by the external periphery of the right eccentric cam 70 to press the first synchronous belt 60, and the second synchronous belt 61 has two corresponding sides extended between the synchronous zoom wheel 47 and the synchronous belt sprocket 51, wherein the external surface of a side adjacent to the left eccentric cam 80 is pressed by the external periphery of the left eccentric cam 80 to press the second synchronous belt 61.

Referring to FIGS. 3 and 4, each zoom unit 35, 45 separately includes a gear 39, 49 disposed at the external side of the ocular module 32, 42 and rotated with the synchronous zoom rod 37 or the synchronous zoom wheel 47. The two gears 39, 49 have Z1 gear threads and Z2 gear threads respectively, and the number of gear threads of these two gears 39, 49 is the same. The synchronous belt sprocket 51 axially and sequentially includes Z3 gear threads 54 disposed on the external surface of the synchronous belt sprocket 51. The lower layer structure 52, 53 includes the same quantity of gear threads 54, and the transmission ratio of the transmission chain is given as follows:
(Z1/Z3)*(Z3/Z2)=1;

The two zoom units 35, 45 can synchronously adjust the zoom in/out factor to achieve the continuous zooming effect. The two synchronous belts 60, 61 include a plurality of equidistantly arranged gear threads 62, 63 disposed at the internal surface of the synchronous belts 60, 61, such that when the two synchronous belts 60, 61 are mounted onto the zoom unit 35, 45 and the synchronous belt sprocket 51 respectively, each gear thread 54 and the two gears 39, 49 on the synchronous belt sprocket 51 can be engaged with the gear threads 62, 63 of each synchronous belt 60, 61 to stably secure each other and avoid any possible slide by mistakes. Further, a sealing ring 48 is installed between each ocular base 31, 41 and the synchronous zoom rod 37 or the synchronous zoom wheel 47 (as shown in FIG. 2) for sealing the gap between each ocular module 32, 42 and the synchronous zoom rod 37 or synchronous zoom wheel 47.

Referring to FIGS. 1, 3 and 4, the synchronous belt sprocket 51 is driven to rotate the first synchronous belt 60 when the synchronous zoom rod 37 rotates; and the second synchronous belt 61 is driven to rotate the synchronous zoom wheel 47 when the synchronous belt sprocket 51 rotates. The synchronous zoom rod 37 and the synchronous zoom wheel 47 reciprocally adjust the relative position of each zoom lens 46 by the rotation of the two synchronous belts 60, 61, so as to achieve the effect of accurately and synchronously changing the zoom-in factor.

Referring to FIG. 3, the right eccentric cam 70 comprises a first wheel rim 71 and a first fixed pillar 73, and the left eccentric cam 80 comprises a second wheel rim 81 and a second fixed pillar 83. The two fixed pillars 73, 83 are fixed separately onto their ocular bases 31, 41, and the two wheel rims 71, 81 at their central position separately include an opening 72, 82, and the internal diameter of each opening 72, 82 is larger than the external diameter of each fixed pillar 73, 83. Each wheel rim 71, 81 has an opening 72, 82 for sheathing the fixed pillar 73, 83 and movably limiting the parallel displacement of each fixed pillar 73, 83. If the external edge of each wheel rim 71, 81 compresses the external surface of the synchronous belt 61, the position of each wheel rim 71, 81 will be restricted accordingly, such that the internal surface of each opening 72, 82 disposed between the wheel rims 71, 81 presses the fixed pillar 73, 83 at a position proximate to the synchronous belt 61, 62. If any one of the synchronous belts 61, 62 rotates, the wheel rims 71, 81 restricted by the synchronous belts 61, 62 rotates along the axis of the fixed pillar 73, 83 with the rotation of the synchronous belt 61, 62. Now, the position where the internal edge of the opening 72, 82 of each wheel rim 71, 81 is in contact with the fixed pillar can be changed as the wheel rims 71, 81 rotate. The wheel rims 71, 81 are consisted of a ball bearing 74, 84 or a ball bearing base coupled to an installed each ocular base 34, 41, so that the design of the ball bearing 74, 84 can greatly reduce the resistance when the wheel rims rotate.

Referring to FIGS. 1 to 3, it is noteworthy to point out that each sealing ring 48 is installed in the binocular telescope 20 and coupled to any two components such as the object lens ring of the object lens module 21 and the object lens 22 of the object lens module 21, the lens barrels 30, 40, the two elevation driving rods 25, the left lens barrel 40 and the right lens barrel 30, the synchronous zoom rod 37 and the right ocular base 31, each ocular module 32, 42 and its ocular base 31, 41, and a fixed frame of the ocular module 32, 42 and the ocular lens 34, 44 on the last surface of the ocular module 32, 42, so as to closely connect any two components. Each component is coated with a sealant to prevent the formation of gaps, and the two ocular bases 31, 41 are coupled to a sealing cover board 28 and covered onto the synchronous zoom rod 37, synchronous zoom wheel 47, eccentric cams 70, 80 and synchronous belts 61, 62 for sealing the gap between two sealing cover boards 28 and the ocular bases 31, 41.

It is noteworthy to point out that if the 10˜22*50 binocular telescopes produced according to the concept of the present invention is emerged into water at the depth of 1 meter for an hour and then removed from the water to take a high/low temperature test, no frost will be formed in the lens at −20° C. and no dew will be formed in the lens at 50° C. Each adjusting operating position can be operated normally, and the sealing is still reliable, and thus the binocular telescope of the invention can effectively achieve the effects of isolating water vapor, resisting water and molds, as well as adjusting the focal distance and magnification factor.

What is claimed is:

1. A waterproof zoom binocular telescope, comprising:
a right lens barrel;
a right ocular base, disposed at an end of said right lens barrel;
a right ocular module, disposed on said right ocular base;
a right zoom unit, built into said right ocular module and including a plurality of zoom lenses installed sequentially in said right zoom unit and a synchronous zoom rod disposed at an external side of said right ocular module for driving and changing a relative position between said zoom lenses;
a left lens barrel;
a left ocular base, disposed on an end of said left lens barrel;
a left ocular module, disposed on said left ocular base;
a left zoom unit, built in said left ocular module and including a plurality of zoom lenses sequentially installed therein, a synchronous zoom wheel disposed at an external side of said left ocular module and rotated synchronously with said synchronous zoom rod, and said synchronous zoom wheel being capable of driving to change a relative position between said zoom lenses;
an axle, with both sides pivotally and respectively coupled to said right lens barrel and said left lens barrel;
a synchronous belt sprocket, installed at a middle position of connecting said left ocular base and said right ocular base and coaxially connected to said axle;
a first synchronous belt, mounted onto said right zoom unit and said synchronous belt sprocket for rotating with said synchronous zoom rod; and
a second synchronous belt, mounted onto said left zoom unit and said synchronous belt sprocket for rotating with said synchronous belt sprocket and driving said synchronous zoom wheel of said left zoom unit to rotate.

2. The binocular telescope of claim 1, further comprising:
a right eccentric cam, installed between two external common tangents of said right zoom unit and said synchronous belt sprocket, and an external periphery of said right eccentric cam facing a side of a line of centers of said synchronous zoom rod and said synchronous belt sprocket and being coupled with an external side of said first synchronous belt; and
a left eccentric cam, installed between two external common tangents of said left zoom unit and said synchronous belt sprocket, and an external periphery of said left eccentric cam facing a side of a line of centers of said synchronous zoom wheel and said synchronous belt sprocket and coupled to an external side of said second synchronous belt.

3. The binocular telescope of claim 2, wherein said left eccentric cam further comprises:
a first fixed pillar, fixed onto said left ocular base;
a first wheel rim, having an opening disposed at the central position of said first wheel rim and the internal diameter of said opening being larger than the internal diameter of said first fixed pillar and sheathed into said first fixed pillar;
and said right eccentric cam further comprises:
a second fixed pillar, fixed onto said right ocular base; and
a second wheel rim, having an opening disposed at the central position of said second wheel rim, and the internal diameter of said opening being larger than the internal diameter of said second fixed pillar and sheathed into said second fixed pillar.

4. The binocular telescope of claims 2, wherein said synchronous belt sprocket further comprises:
an upper layer structure, movably coupled to said second synchronous belt; and
a lower layer structure, movably coupled to said first synchronous belt.

5. The binocular telescope of claims 3, wherein said synchronous belt sprocket further comprises:
an upper layer structure, movably coupled to said second synchronous belt; and
a lower layer structure, movably coupled to said first synchronous belt.

6. The binocular telescope of claim 4, further comprising a sealing ring disposed separately between said right ocular base and said synchronous zoom rod, and between said left ocular base and said synchronous zoom wheel.

7. The binocular telescope of claim 5, further comprising a sealing ring disposed separately between said right ocular base and said synchronous zoom rod, and between said left ocular base and said synchronous zoom wheel.

8. The binocular telescope of claim 6, wherein said right zoom unit includes a gear disposed outside said right ocular module and rotated with said synchronous zoom rod for mounting said first synchronous belt, and said left zoom unit includes a gear disposed outside said left ocular module and rotated with said synchronous zoom wheel for mounting said second synchronous belt, and said synchronous belt sprocket includes a plurality of gear threads disposed on an external side of said synchronous belt sprocket for engaging said two gears.

9. The binocular telescope of claim 7, wherein said right zoom unit includes a gear disposed outside said right ocular module and rotated with said synchronous zoom rod for mounting said first synchronous belt, and said left zoom unit includes a gear disposed outside said left ocular module and rotated with said synchronous zoom wheel for mounting said second synchronous belt, and said synchronous belt sprocket includes a plurality of gear threads disposed on an external side of said synchronous belt sprocket for engaging said two gears.

10. The binocular telescope of claim 8, wherein said two wheel rims are comprised of a ball bearing.

11. The binocular telescope of claim 9, wherein said two wheel rims are comprised of a ball bearing.

12. The binocular telescope of claim 10, further comprising two sealing cover boards installed separately onto said corresponding ocular base for covering said corresponding synchronous zoom rod, synchronous zoom wheel, eccentric cam and synchronous belt disposed between said ocular bases.

13. The binocular telescope of claim 11, further comprising two sealing cover boards installed separately onto said corresponding ocular base for covering said corresponding synchronous zoom rod, synchronous zoom wheel, eccentric cam and synchronous belt disposed between said ocular bases.

14. A waterproof zoom binocular telescope, comprising two lens barrels and an axle, and an end of said two lens barrels separately including an ocular base, a synchronous belt sprocket disposed at a position of connecting said two ocular bases and coaxially coupled with said axle, and said two ocular bases separately including an ocular module, and said two ocular modules separately include a zoom unit therein and said each zoom unit and said synchronous belt sprocket being mounted with a synchronous belt to define a transmission chain structure, and an eccentric cam being disposed between two external common tangents of said each ocular module and said synchronous belt sprocket, and an external periphery of said two eccentric cam facing a side of a line of centers of said each zoom unit and said synchronous belt sprocket is coupled separately an external side facing said synchronous belt.
